(19) United States
(12) Patent Application Publication
(10) Pub. No.: US 2019/0113085 A1
(43) Pub. Date: Apr. 18, 2019

(54) TURBOMACHINE TRAIN AND METHOD FOR COUPLING THE TURBOMACHINE TRAIN

(71) Applicant: Siemens Aktiengesellschaft, Munich (DE)

(72) Inventors: David Veltmann, Essen (DE); Martin Bennauer, Bottrop (DE); Christoph Schindler, Essen (DE)

(73) Assignee: Siemens Aktiengesellschaft, Munich (DE)

(21) Appl. No.: 16/089,605

(22) PCT Filed: Mar. 15, 2017
(86) PCT No.: PCT/EP2017/056118

§ 371 Date: Sep. 28, 2018

(30) Foreign Application Priority Data
Apr. 12, 2016 (EP) 16164886.0

(51) Int. Cl. F16D 23/10; F01D 13/00; F02C 6/02; F02C 7/277; F02B 37/11; F16D 23/04

(52) U.S. Cl. CPC F16D 23/10; F16D 2500/50638; F02C 6/02; F02C 7/277; F02B 37/11; F16D 23/04; F05D 2220/72; F05D 2270/023; F05D 2270/04; F05D 2270/13; F05D 2270/304; F05D 2270/809; F16D 2300/18; F16D 2500/30816; F16D 2500/30825; F01D 13/003

(57) ABSTRACT

A turbomachine train with two shaft parts which each have a fixedly attached grooved wheel, with a first overrunning clutch, with two rotational speed sensors and with a control device. The clutch is designed to couple and decouple the first shaft part to and from the second shaft part. The first rotational speed sensor measures the rotational speed of the first grooved wheel. The second rotational speed sensor measures the rotational speed of the second grooved wheel. The control device determines the differential angle between the first shaft part and the second shaft part and accelerates the turbomachines, with an acceleration value determined on the basis of the measured rotational speeds and on the basis of the differential angle, such that the two shaft parts couple together at a predetermined target coupling angle.

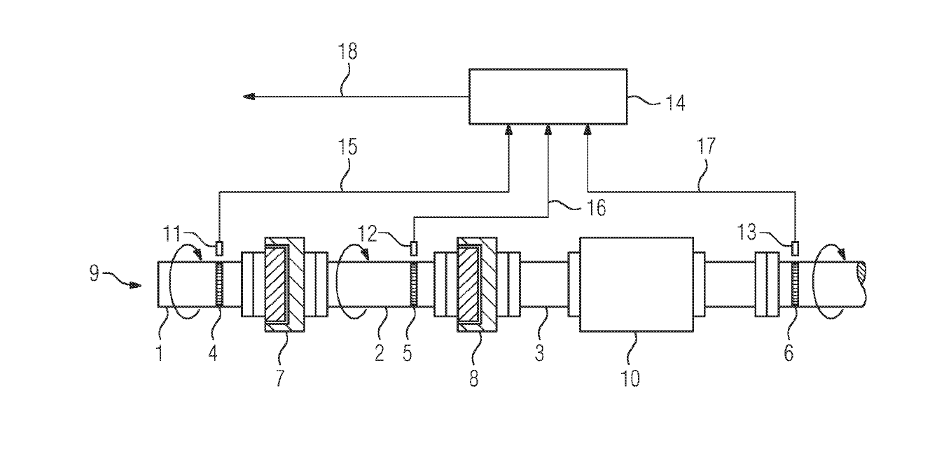

### CROSS REFERENCE TO RELATED APPLICATIONS

This application is the US National Stage of International Application No. PCT/EP2017/056118 filed Mar. 15, 2017, and claims the benefit thereof. The International Application claims the benefit of European Application No. EP16164886 filed Apr. 12, 2016. All of the applications are incorporated by reference herein in their entirety.

### FIELD OF INVENTION

The invention relates to a turbomachine train and method for coupling the turbomachine train.

### BACKGROUND OF INVENTION

A turbomachine train with turbomachines, such as for example in a power plant, can be excited to create vibrations during rotation of the turbomachine train. The vibrations of the turbomachine train are, however, disadvantageous because they shorten its service life.

The turbomachine train can be divided into shaft sections with the aid of a clutch, wherein the shaft sections can rotate independently of each other in the decoupled state and rotate together in the coupled state. For example, one shaft section can have a gas turbine and a steam turbine of the other shaft section is driven by its waste heat. During startup of the gas turbine, sufficient waste heat is not yet available in order to drive the steam turbine. In order to prevent ventilation inside the steam turbine the two shaft sections are conventionally only intercoupled when the shaft section with the steam turbine has been accelerated to the rotational speed of the shaft section with the gas turbine. In a steam thermal power plant, for example, two shaft sections each with a steam turbine can also be coupled and decoupled by means of a clutch. When a large quantity of steam is being extracted for a heat emission of the steam thermal power plant, the shaft sections can be decoupled so that one of the two steam turbines does not need to be exposed to throughflow of steam.

It has been proved that the vibration behavior of the turbomachine train depends on the coupling angle of the two shaft sections. The more accurately a targeted coupling angle with a good vibration behavior can be introduced, the less the turbomachine train vibrates.

### SUMMARY OF INVENTION

It is therefore the object of the invention to create a method for coupling two shaft sections in which a desired targeted coupling angle of the two shaft sections can be achieved reliably and with a high degree of accuracy.

The turbomachine train according to the invention has a first shaft section which has a first turbomachine and a first slotted wheel which is fixedly attached on the first shaft section, a second shaft section which has a second turbomachine and a second slotted wheel which is fixedly attached on the second shaft section, a first overrunning clutch which is designed for coupling the first shaft section to the second shaft section when the rotational speed of the first shaft section is equal to the rotational speed of the second shaft section, and for decoupling the first shaft section from the second shaft section when the rotational speed of the first shaft section is lower than the rotational speed of the second shaft section, a first tachometer which is designed for measuring the rotational speed of the first slotted wheel, a second tachometer which is designed for measuring the rotational speed of the second slotted wheel, and a control device which is designed for determining the differential angle between the first shaft section and the second shaft section and, at a rotational speed of the second shaft section which is lower than a nominal rotational speed of the turbomachine train and at a rotational speed of the first shaft section which is lower than the rotational speed of the second shaft section, for accelerating the first turbomachine and/or the second turbomachine, with an acceleration value which is determined on the basis of the measured rotational speed and the differential angle, in such a way that the two shaft sections intercouple at a predetermined targeted coupling angle.

The method according to the invention for coupling a turbomachine train, with a first shaft section which has a first turbomachine and a first slotted wheel which is fixedly attached on the first shaft section, a second shaft section which has a second turbomachine and a second slotted wheel which is fixedly attached on the second shaft section, and a first overrunning clutch which is designed for coupling the first shaft section to the second shaft section when the rotational speed of the first shaft section is equal to the rotational speed of the second shaft section, and for decoupling the first shaft section from the second shaft section when the rotational speed of the first shaft section is lower than the rotational speed of the second shaft section, features the steps: a) rotating the second shaft section at a rotational speed which is lower than a nominal rotational speed of the turbomachine train and rotating the first shaft section at a rotational speed which is lower than the rotational speed of the second shaft section; b) measuring the rotational speed of the first slotted wheel and the second slotted wheel; c) measuring the differential angle between the first shaft section and the second shaft section; d) accelerating the first turbomachine and/or the second turbomachine, with an acceleration value which is determined on the basis of the measured rotational speeds and the differential angle, in such a way that the two shaft sections intercouple at a predetermined targeted coupling angle.

Because the slotted wheels are fixedly connected to the respective shaft section, the measured rotational speed of the slotted wheels is identical to the rotational speed of the shaft section which is fixedly connected to the respective slotted wheel. On the basis of the measured rotational speeds of the two slotted wheels and the differential angle, the acceleration value can then be calculated, on the basis of which the two shaft sections intercouple at a predetermined targeted coupling angle. As a result of the measuring of the rotational speeds of the slotted wheels, the rotational speed of the shaft sections can be determined with a high degree of accuracy on account of the high number of slots in the slotted wheels. This especially applies at the low rotational speeds which are lower than the nominal rotational speed of the turbomachine train. As a result of this high degree of accuracy of the rotational speeds, the acceleration value can also be established with a high degree of accuracy, as a result of which the targeted coupling angle of the two shaft sections can be achieved reliably and with a high degree of accuracy.

The acceleration value can be both positive and negative, by which a faster rotation and a slower rotation of the respective shaft section can be meant. In this case, for coupling the two shaft sections the first shaft section can be rotated quickly and/or the second shaft section can be rotated more slowly. In the event that both the first shaft section is rotated more quickly and the second shaft section is rotated more slowly two acceleration values, one value for each shaft section, are to be calculated.

The slotted wheels have a multiplicity of slots which are arranged in an unevenly distributed manner along the circumference of the turbomachine train, and the control device is designed for determining the differential angle between two adjacent shaft sections by reference to the unevenly distributed slot. As a result, the differential angle can be determined in a particularly simple manner. It is in particular unnecessary to provide a further marking on each shaft section to determine the differential angle by reference to it.

It is advantageous that the turbomachine train has a third shaft section which has a third turbomachine and a third slotted wheel which is fixedly attached on the third shaft section, a second overrunning clutch which is designed for coupling the second shaft section to the third shaft section when the rotational speed of the second shaft section is equal to the rotational speed of the third shaft section, and for decoupling the second shaft section from the third shaft section when the rotational speed of the second shaft section is lower than the rotational speed of the third shaft section, and a third tachometer which is designed for measuring the rotational speed of the third slotted wheel, wherein the control device is designed for determining the differential angle between the second shaft section and the third shaft section and, at a rotational speed of the third shaft section which is lower than the nominal rotational speed of the turbomachine train and at a rotational speed of the second train section which is lower than the rotational speed of the third train section, for accelerating the second turbomachine and/or the third turbomachine, with a second acceleration value which is determined on the basis of the measured rotational speeds of the second slotted wheel and the third slotted wheel and also the differential angle between the second shaft section and the third shaft section, in such a way that the second shaft section is coupled with the third shaft section at a predetermined second targeted coupling angle.

That which was explained for the coupling of the first and second shaft sections similarly applies to the coupling of the second and third shaft sections.

At a rotational speed of the second shaft section which is lower than a fifth of the nominal rotational speed of the turbomachine train, the control device is advantageously designed for coupling the first shaft section to the second shaft section and/or, at a rotational speed of the third shaft section which is lower than a fifth of the nominal rotational speed of the turbomachine train, for coupling the second shaft section to the third shaft section at a respective targeted coupling angle. At such low rotational speeds, the rotational speeds can also be measured with a high degree of accuracy, as a result of which the respective targeted coupling angle can be achieved with the high degree of accuracy.

The slotted wheels advantageously have a multiplicity of slots which are delimited by flanks and for measuring the respective rotational speed the tachometers designed for sensing the flanks. By the sensing of the flanks, the rotational speeds of the slotted wheels can advantageously be measured with a particularly high degree of accuracy.

It is advantageous that the control device, during acceleration of the respective turbomachine, is designed for determining a new differential angle and for accelerating the respective turbomachine with a new acceleration value, which is determined on the basis of new measured rotational speeds and the new differential angle, in such a way that the respective targeted coupling angle is achieved. As a result, the accuracy with which the targeted coupling angle can be achieved can be further increased. In this case, the new acceleration value can also be determined repeatedly or even continuously.

The turbomachine train advantageously has a third shaft section which has a third turbomachine and a third slotted wheel which is fixedly attached on the third shaft section, and a second overrunning clutch which is designed for coupling the second shaft section to the third shaft section when the rotational speed of the second shaft section is equal to the rotational speed of the third shaft section, and for decoupling the second shaft section from the third shaft section when the rotational speed of the second shaft section is lower than the rotational speed of the third shaft section, and the method advantageously features the steps: a1) rotating the third shaft section at a rotational speed which is lower than the nominal rotational speed of the turbomachine train and rotating the second shaft section at a rotational speed which is lower than the rotational speed of the third shaft section; b1) measuring the rotational speed of the third slotted wheel; c1) measuring the differential angle between the second shaft section and the third shaft section; d1) accelerating the second turbomachine and/or the third turbomachine, with an acceleration value which is determined on the basis of the measured rotational speed of the second slotted wheel and the third slotted wheel and the differential angle between the second shaft section and the third shaft section, in such a way that the two shaft sections intercouple at a predetermined second targeted coupling angle.

In step a) the second shaft section and/or in step a1) the third shaft section are/is advantageously rotated at a rotational speed which is lower than a fifth of the nominal rotational speed of the turbomachine train.

It is advantageous that the slotted wheels have a multiplicity of slots which are delimited by flanks, and for measuring the respective rotational speed the flanks are sensed. The slotted wheels have a multiplicity of slots which are arranged in an unevenly distributed manner along the circumference of the turbomachine train, and the differential angle between two adjacent shaft sections is determined by reference to the unevenly distributed slots.

It is advantageous that the method is conducted during startup of the turbomachine and/or, in the event that at least one of the shaft sections is decoupled from the rest of the turbomachine train, during shut down of the gas turbine train. It is advantageous that in step d) and/or in d1) a new differential angle is determined during the acceleration of the respective turbomachine and the respective turbomachine is accelerated with a new acceleration value, which is determined on the basis of new measured rotational speeds and the new differential angle, in such a way that the respective targeted coupling angle is achieved. In this case, the step d) can be carried out before the step d1) or the step d1) can be carried out before the step d).

1. A turbomachine train, comprising:
a first shaft section which has a first turbomachine and first slotted wheel which is fixedly attached on the first shaft section,
a second shaft section which has a second turbomachine and second slotted wheel which is fixedly attached on the second shaft section,
a first overrunning clutch which is designed for coupling the first shaft section to the second shaft section when the rotational speed of the first shaft section is equal to the rotational speed of the second shaft section, and for decoupling the first shaft section from the second shaft section when the rotational speed of the first shaft section is lower than the rotational speed of the second shaft section,
a first tachometer which is designed for measuring the rotational speed of the first slotted wheel,
a second tachometer which is designed for measuring the rotational speed of the second slotted wheel, and
a control device which is adapted to determine the differential angle between the first shaft section and the second shaft section and, at a rotational speed of the second shaft section which is lower than a nominal rotational speed of the turbomachine train, and at a rotational speed of the first shaft section which is lower than the rotational speed of the second shaft section, is adapted to accelerate the first turbomachine and/or the second turbomachine, with an acceleration value which is determined on the basis of the measured rotational speeds and the differential angle, in such a way that the two shaft sections intercouple at a predetermined targeted coupling angle,
wherein the slotted wheels have a multiplicity of slot which are arranged in an unevenly distributed manner along the circumference of the turbomachine train, and
wherein the control device is adapted to determine the differential angle between two adjacent shafts sections by reference to the unevenly distributed slots.

2. The turbomachine train as claimed in claim 1, further comprising:
a third shaft section which has a third turbomachine and a third slotted wheel which is fixedly attached on the third shaft section,
a second overrunning clutch which is designed for coupling the second shaft section to the third shaft section when the rotational speed of the second shaft section is equal to the rotational speed of the third shaft section, and for decoupling the second shaft section from the third shaft section when the rotational speed of the second shaft section is lower than the rotational speed of the third shaft section, and
a third tachometer which is designed for measuring the rotational speed of the third slotted wheel,
wherein the control device is adapted to determine the differential angle between the second shaft section and the third shaft section and, at a rotational speed of the third shaft section which is lower than the nominal rotational speed of the turbomachine train, and at a rotational speed of the second train section which is lower than the rotational speed of the third train section, is adapted to accelerate the second turbomachine and/or the third turbomachine, with a second acceleration value which is determined on the basis of the measured rotational speeds of the second slotted wheel and the third slotted wheel and the differential angle between the second shaft section and the third shaft section, in such a way that the second shaft section couples with third shaft section at a predetermined second targeted coupling angle.

3. The turbomachine train as claimed in claim 1,
wherein the control device, at a rotational speed of the second shaft section which is lower than a fifth of the nominal rotational speed of the turbomachine train, is adapted to couple the first shaft section to the second shaft section at the respective targeted coupling angle.

4. The turbomachine train as claimed in claim 1,
wherein the slotted wheels have a multiplicity of slots which are delimited by flanks, and the tachometers are designed for sensing the flanks for measuring the respective rotational speed.

5. The turbomachine train as claimed in claim 1,
wherein the control device is designed for determining a new differential angle during the acceleration of the respective turbomachine and for accelerating the respective turbomachine, with a new acceleration value which is determined on the basis of new measured rotational speeds and the new differential angle, in such a way that the respective targeted coupling angle is achieved.

6. A method for coupling of turbomachine train, with a first shaft section which has a first turbomachine and a first slotted wheel which is fixedly attached on the first shaft section, a second shaft section which has a second turbomachine and a second slotted wheel which is fixedly attached on the second shaft section, and a first overrunning clutch which is designed for coupling the first shaft section to the second shaft section when the rotational speed of the first shaft section is equal to the rotational speed of the second shaft section, and for decoupling the first shaft section from the second shaft section when the rotational speed of the first shaft section is lower than the rotational speed of the second shaft section, the method comprising:
a) rotating the second shaft section at a rotational speed which is lower than a nominal rotational speed of the turbomachine train and rotating the first shaft section at a rotational speed which is lower than the rotational speed of the second shaft section;
b) measuring the rotational speeds of the first slotted wheel and the second slotted wheel;
c) measuring the differential angle between the first shaft section and the second shaft section;
d) accelerating the first turbomachine and/or the second turbomachine, with an acceleration value which is determined on the basis of the measured rotational speeds and the differential angle, in such a way that the two shaft sections intercouple at a predetermined targeted coupling angle,
wherein the slotted wheels have a multiplicity of slots which are arranged in an unevenly distributed manner along the circumference of the turbomachine train, and the differential angle between two adjacent shaft sections is determined by reference to the unevenly distributed slots.

7. The method as claimed in claim 6, wherein the turbomachine train has a third shaft section which has a third turbomachine and a third slotted wheel which is fixedly attached on the third shaft section, and a second overrunning clutch which is designed for coupling the second shaft section to the third shaft section when the rotational speed of the second shaft section is equal to the rotational speed of the third shaft section, and for decoupling the second shaft section from the third shaft section when the rotational speed of the second shaft section is lower than the rotational speed of the third shaft section, the method further comprising:
a1) rotating the third shaft section at a rotational speed which is lower than a nominal rotational speed of the turbomachine train and rotating the second shaft section at a rotational speed which is lower than the rotational speed of the third shaft section;
b1) measuring the rotational speed of the third slotted wheel;
c1) measuring the differential angle between the second shaft section and the third shaft section;
d1) accelerating the second turbomachine and/or the third turbomachine, with an acceleration value which is determined on the basis of the measured rotational speeds of the second slotted wheel and the third slotted wheel and the differential angle between the second shaft section and the third shaft section, in such a way that the two shaft sections intercouple at a predetermined second targeted coupling angle.

8. The method as claimed in claim 6,
wherein in step a) the second shaft section is rotated at a rotational speed which is lower than a fifth of the nominal rotational speed of the turbomachine train.

9. The method as claimed in claim 6,
wherein the slotted wheels have a multiplicity of slots which are delimited by flanks, and the flanks are sensed for measuring the respective rotational speed.

10. The method as claimed in claim 6,
wherein the method is conducted during startup of the turbomachine train and/or, in the event that at least one of the shaft sections is decoupled from the rest of the turbomachine train, during shutdown of the turbomachine train.

11. The method as claimed in claim 6,
wherein in step d) a new differential angle is determined during the acceleration of the respective turbomachine and the respective turbomachine is accelerated, with a new acceleration value which is determined on the basis of new measured rotational speeds and the new differential angle, in such a way that the respective targeted coupling angle is achieved.

12. The turbomachine train as claimed in claim 2,
wherein the control device, at a rotational speed of the third shaft section which is lower than a fifth of the nominal rotational speed of the turbomachine train, is adapted to couple the second shaft section to the third shaft section at the respective targeted coupling angle.

13. The method as claimed in claim 7,
wherein in step a1) the third shaft section is rotated at a rotational speed which is lower than a fifth of the nominal rotational speed of the turbomachine train.

14. The method as claimed in claim 7,
wherein in step d1) a new differential angle is determined during the acceleration of the respective turbomachine and the respective turbomachine is accelerated, with a new acceleration value which is determined on the basis of new measured rotational speeds and the new differential angle, in such a way that the respective targeted coupling angle is achieved.
